(19) United States
(12) Patent Application Publication
(10) Pub. No.: US 2015/0107072 A1
(43) Pub. Date: Apr. 23, 2015

(54) FATIGUE RESISTANT TURBINE THROUGH BOLT

(71) Applicants: Kazim Ozbaysal, Orlando, FL (US); Zafir A. M. Abdo, Orlando, FL (US); Kenneth K. Starr, Orlando, FL (US); Sachin R. Shinde, Oviedo, FL (US)

(72) Inventors: Kazim Ozbaysal, Orlando, FL (US); Zafir A. M. Abdo, Orlando, FL (US); Kenneth K. Starr, Orlando, FL (US); Sachin R. Shinde, Oviedo, FL (US)

(21) Appl. No.: 14/059,528

(22) Filed: Oct. 22, 2013

(51) Int. Cl. F16B 33/06; B23P 9/02

(52) U.S. Cl. CPC F16B 33/06; B23P 9/02
USPC 29/90.01; 411/411

(57) ABSTRACT

A fatigue resistant turbine through bolt formed from a base material covered by a first surface modification and a second surface modification is disclosed. The first surface modification may be in contact with the base material and, in at least one embodiment, may be a low plasticity burnished layer that increases the residual compressive stresses on an outer surface of the turbine through bolt. The second surface modification may cover the first surface modification and, in at least one embodiment, may be a spinel oxide layer on the low plasticity burnished layer. The second surface modification may be positioned on the first surface modification or on the bare turbine through bolt contact surface without low plastiocity burnishing on the shaft of the turbine through bolt. The first and second surface modifications reduce the likelihood of fretting fatigue failures.

### FIELD OF THE INVENTION

The invention relates to one or more surface modifications on a turbine through bolt for reduced fretting fatigue crack initiation and propagation and more particularly, to a turbine through bolt having a low plasticity burnished layer or a spinel oxide layer, or both, to reduce fretting fatigue crack initiation and propagation.

### BACKGROUND OF THE INVENTION

Turbine through bolts made of INCO 718 material have suffered from fretting high cycle fatigue failures at the through bolt seal disk contact location in industrial gas turbine engines, as shown in FIG. 1. Cracking has been initiated by fretting high cycle fatigue, and crack propagation has been determined to be caused by high cycle fatigue.

### SUMMARY OF THE INVENTION

This application is directed to a bolt, such as, but not limited to a fatigue resistant turbine through bolt, formed from a base material covered by a first surface modification or a second surface modification, or both. The first surface modification may be in contact with the base material and, in at least one embodiment, may be a low plasticity burnished layer that increases the residual compressive stresses on an outer surface of the turbine through bolt. The second surface modification may cover the first surface modification and, in at least one embodiment, may be a spinel oxide layer on the low plasticity burnished layer. The first surface modification may be positioned on one or more turbine through bolt contact surfaces positioned on a shaft of the turbine through bolt. The second surface modification may be positioned on the first surface modification on the turbine through bolt contact surface positioned on the shaft of the turbine through bolt. The first and second surface modifications may reduce the likelihood of fretting fatigue failures.

The turbine through bolt may be formed from a base material covered by a first surface modification and a second surface modification. The first surface modification may be in contact with the base material and may be a low plasticity burnished layer that increases the residual compressive stresses on an outer surface of the turbine through bolt. The second surface modification may cover the first surface modification and may be a spinel oxide layer on the low plasticity burnished layer. The base material may be an INCO 718 formed at least from a combination of Ni, Fe, Mo and Cr. In at least one embodiment, the base material may be formed at least from a combination of between 50 percent and 55 percent Nickel, between 17 percent and 21 percent Chromium, up to one percent Cobalt, between 0.65 percent and 1.15 Titanium, between 4.75 percent and 5.5 percent Columbium plus Tantalum, between 0.2 percent and 0.8 percent Aluminum, between 2.8 percent and 3.3 percent Molybdenum and the remainder iron. In at least one embodiment, the base material may include between 12.25 percent and 23.6 percent iron. The first surface modification may be positioned on at least one turbine through bolt contact surface positioned on a shaft of the turbine through bolt. The first surface modification may have a thickness of at least 0.040 inches. The second surface modification may be positioned on the first surface modification on the at least one turbine through bolt contact surface positioned on the shaft of the turbine through bolt. The second surface modification may be formed from spinel oxides of INCO 718 material. In at least one embodiment, the spinel oxide may be formed from (Ni, Fe) oxide; (Ni, Cr, Ti) oxide; (Cr) oxide or other spinel oxides afvored by the compostiion of the base material.

The turbine through bolt may be formed using a method of forming the turbine through bolt with a low coefficient-of-friction surface modification to reduce contact friction stresses. The method may include receiving the turbine through bolt formed from at least one base material. The turbine through bolt may be received after final milling or grinding, or both. The method may include subjecting the turbine through bolt contact surface positioned on the shaft of the turbine through bolt to LPB to induce a residual compressive stress, thereby forming a first surface modification on the turbine through bolt contact surface. Subjecting the turbine through bolt contact surface to LPB may include subjecting the turbine through bolt contact surface to LPB to induce a minimum of 100 ksi residual compressive stress. The method may also include exposing the turbine through bolt to a low temperature stress relief process in an oxidizing environment having a temperature less than 593 degrees Celsius for a period of time between two hours and 48 hours to form a second surface modification on the first surface modification. The step of receiving the turbine through bolt formed from the base material may include receiving the turbine through bolt formed from the base material formed from INCO 718, which may be formed at least from a combination of Ni, Fe, Mo and Cr. In at least one embodiment, the step of receiving the turbine through bolt formed from the base material comprises receiving the turbine through bolt formed from the base material INCO 718, wherein the base material may be formed at least from a combination of between 50 percent and 55 percent Nickel, between 17 percent and 21 percent Chromium, up to one percent Cobalt, between 0.65 percent and 1.15 Titanium, between 4.75 percent and 5.5 percent Columbium plus Tantalum, between 0.2 percent and 0.8 percent Aluminum, between 2.8 percent and 3.3 percent Molybdenum and the remainder iron. In at least one embodiment, the base material may include between 12.25 percent and 23.6 percent iron. After the first surface modification or second surface modification, or both, have been applied to the turbine through bolt, the turbine through bolt should not be machined or heat treated.

An advantage of the turbine through bolt with the first surface modification formed from a low plasticity burnished layer is that the low plasticity burnished layer increases the residual compressive stresses on the turbine through bolt surface, thereby reducing the likelihood of crack initiation and effectively eliminating any current residual tensile surface stresses on the turbine through bolt generated by machining.

Another advantage of the turbine through bolt with the second surface modification formed from a spinel oxide surface modification is that the spinel oxide surface modification forms a low coefficient-of-friction surface modification that prevents the turbine through bolt contact surfaces from being under slip stick condition with the bare metal surfaces of the turbine engine, thereby reducing the likelihood of fretting fatigue.

Yet another advantage of the turbine through bolt is that the spinel oxide surface modification acts as an adherent lubricant and reduces the coefficient of friction, thereby reducing the friction stresses on the contact surfaces.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is perspective view of a turbine through bolt with fracture because the turbine through bolt surface did not include a residual compressive stress or spinal oxide layer.

FIG. 2 is a graph showing a comparison of depth of compression versus residual stress for each of laser shock processing (LSP), low plasticity burnished layer (LPB), gravity peen (GP), and shot peening (SP) for INCO 718.

FIG. 3 is a graph of percent cold work distribution for percent cold work versus depth for each of laser shock processing (LSP), low plasticity burnished layer (LPB), gravity peen (GP), and shot peening (SP) for INCO 718.

FIG. 4 is a graph of a fretting fatigue curve for INCO 718 at room temperature versus above 500 degrees Celsius showing the fretting fatigue endurance limit has increased nearly 300 percent above 500 degrees Celsius due to spinel oxide formation on the INCO 718.

### DETAILED DESCRIPTION OF THE INVENTION

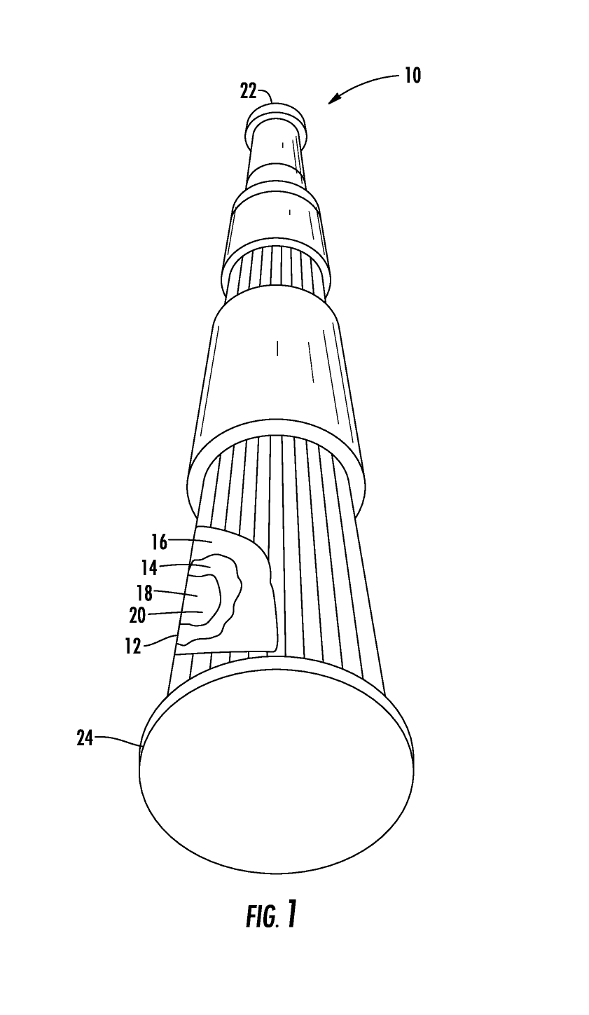

As shown in FIGS. 1-4, this invention is directed to a turbine through bolt 10, such as, but not limited to a fatigue resistant turbine through turbine through bolt 10, formed from a base material 12 covered by a first surface modification 14 or a second surface modification 16, or both. The first surface modification 14 may be in contact with the base material 12 and, in at least one embodiment, may be a low plasticity burnished layer that increases the residual compressive stresses on an outer surface 18 of the turbine through bolt 10. The second surface modification 16 may cover the first surface modification 14 and, in at least one embodiment, may be a spinel oxide layer on the low plasticity burnished layer. The first surface modification 14 may be positioned on one or more turbine through bolt contact surfaces 20 positioned on a shaft 24 of the turbine through bolt 10. The second surface modification 16 may be positioned on the first surface modification 14 on the turbine through bolt contact surface 20 positioned on the shaft 24 of the turbine through bolt 10. The first and second surface modifications 14, 16 may reduce the likelihood of fretting and contact fatigue failures.

The turbine through bolt 10 may be formed from a turbine through bolt head 22 coupled to a shaft 24 extending laterally therefrom. The turbine through bolt head 22 may be larger than the shaft 24 and may include one or more turbine through bolt contact surfaces 20 on side of the bold head 22 positioned adjacent to the shaft 24. The shaft 24, turbine through bolt length and other aspects may have any appropriate size. The turbine through bolt 10 may be formed from a base material 12 such as, but not limited to, INCO 718. In at least one embodiment, the base material may be formed at least from a combination of between 50 percent and 55 percent Nickel, between 17 percent and 21 percent Chromium, up to one percent Cobalt, between 0.65 percent and 1.15 Titanium, between 4.75 percent and 5.5 percent Columbium plus Tantalum, between 0.2 percent and 0.8 percent Aluminum, between 2.8 percent and 3.3 percent Molybdenum and the remainder iron. In at least one embodiment, the base material may include between 12.25 percent and 23.6 percent iron. In at least one embodiment, the INCO 718 may be formed from a high strength nickel base superalloy used for cryogenic temperatures up to long term service at 650 degrees Celsius. The INCO 718 may be fabricated and may be welded in either the annealed or precipitation (age) hardened condition. The INCO 718 may be annealed at between 925 degrees Celsius and 1010 degrees Celsius and air cooled or cooled via a faster method. The INCO 718 may then be aged at 718 degrees Celsius for eight hours plus aged at 621 degrees Celsius for about eight hours for a total aging time of 18 hours via air cooling. INCO 718 may show a contraction of 0.0008 inch/inch after precipitation hardening.

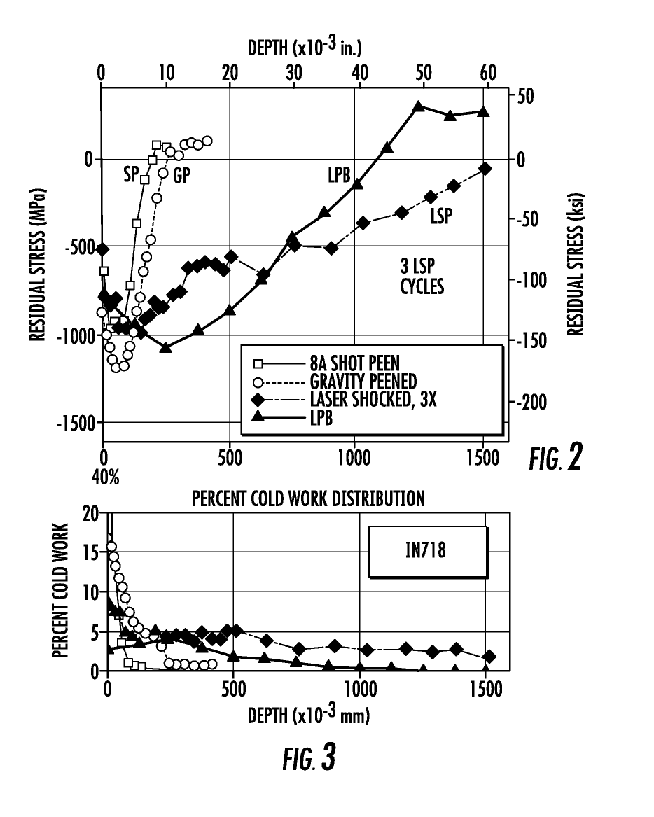

The turbine through bolt 10 may be formed from the base material 12 covered by the first surface modification 14 and the second surface modification 16. The first surface modification 14 may be in contact with the base material 12 and may be formed from a low plasticity burnished layer that increases the residual compressive stresses on the outer surface 18 of the turbine through bolt 10. The first surface modification 14 may have a thickness of at least 0.040 inches. The first surface modification 14 may be positioned on the turbine through bolt contact surface 20 positioned on the shaft 24 of the turbine through bolt 10. The first surface modification 14 may be formed from a low plasticity burnished layer formed from materials such as, but not limited to, IN 718. The low plasticity burnished layer has been determined to be a superior surface modification 14 as compared to each of laser shock processing (LSP), gravity peen (GP), and shot peening (SP) for INCO 718, as shown in FIGS. 2 and 3.

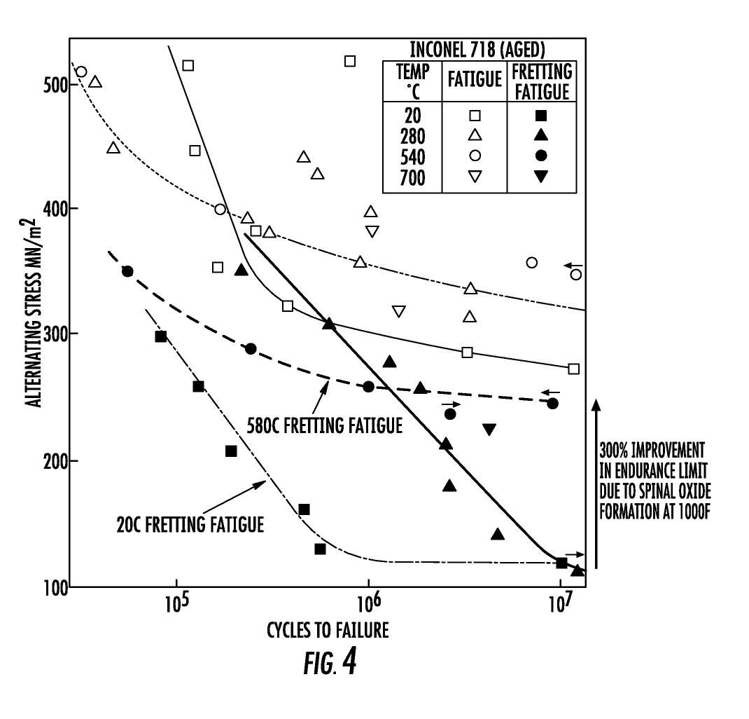

In one embodiment, the second surface modification 16 may be applied directly to the base material 12 and may be used without the first surface modification 14. In another embodiment, the second surface modification 16 may be applied on the first surface modification 14 already applied to the base material 12. In particular, the second surface modification 16 may be positioned on the first surface modification 14 on the turbine through bolt contact surface 20 positioned on the shaft 24 of the turbine through bolt. In at least one embodiment, the second surface modification 16 may be a spinel oxide layer on the low plasticity burnished layer forming the first surface modification 14. The second surface modification 16 may be formed from one or more of (Ni Fe) oxide; (Ni, Cr, Ti; Cr) oxide, (Cr) oxide or other spinel oxides favored by the composition of the base metal. As shown in FIG. 4, the spinel oxide formation above 500 degrees Celsius resulted in a 300 percent improvement in endurance limit of the INCO 718 for fretting fatigue.

The turbine through bolt 10 may be formed using a method of forming the turbine through bolt 10 with a low coefficient-of-friction surface modification to reduce contact friction stresses. The method may include receiving the turbine through bolt 10 formed from at least one base material 12. The turbine through bolt 10 may be received after final milling or grinding, or both. The method may include subjecting the turbine through bolt contact surface 20 positioned on the shaft 24 of the turbine through bolt 10 to LPB to induce a residual compressive stress, thereby forming a first surface modification 14 on the turbine through bolt contact surface 20. Subjecting the bolt contact surface 20 to LPB may include inducing a minimum of 100 ksi residual compressive stress. The method may also include exposing the turbine through bolt 10 to a low temperature stress relief process in an oxidizing environment having a temperature less than 593 degrees Celsius for a period of time between two hours and 48 hours to form a second surface modification 16 on the first surface modification 14 on the turbine through bolt contact surface 20 positioned on a shaft 24 of the turbine through bolt 10. The step of receiving the turbine through bolt 10 formed from the base material 12 may include receiving the turbine through bolt 10 formed from the base material 12 formed from INCO 718, which may be formed at least from a combination of Ni, Fe, Mo and Cr. In at least one embodiment, the step of receiving the turbine through bolt 10 formed from the base material 12 comprises receiving the turbine through bolt 10 formed from the base material INCO 718, wherein the base material 12 may be formed at least from a combination of 50 percent Ni, 2.8 percent Mo and 17 percent Cr. After the first surface modification 14 or second surface modification 16, or both, have been applied to the turbine through bolt 10, the turbine through bolt 10 should not be machined or heat treated.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A turbine through bolt, comprising:
a base material covered by a first surface modification and a second surface modification;
wherein the first surface modification is in contact with the base material and is a low plasticity burnished layer that increases the residual compressive stresses on an outer surface of the turbine through bolt; and
wherein the second surface modification covers the first surface modification and is a spinel oxide layer on the low plasticity burnished layer.

2. The turbine through bolt of claim 1, wherein the base material is INCO 718 formed at least from a combination of Ni, Fe, Mo and Cr.

3. The turbine through bolt of claim 1, wherein the base material is formed at least from a combination of between 50 percent and 55 percent Nickel, between 17 percent and 21 percent Chromium, up to one percent Cobalt, between 0.65 percent and 1.15 Titanium, between 4.75 percent and 5.5 percent Columbium plus Tantalum, between 0.2 percent and 0.8 percent Aluminum, between 2.8 percent and 3.3 percent Molybdenum and the remainder iron.

3. The turbine through bolt of claim 1, wherein the second surface modification is formed from INCO 718.

4. The turbine through bolt of claim 1, wherein the first surface modification has a thickness of at least 0.040 inches.

5. The turbine through bolt of claim 1, wherein the first surface modification is positioned on at least one turbine through bolt contact surface positioned on a shaft of the turbine through bolt.

6. The turbine through bolt of claim 5, wherein the second surface modification is positioned on the first surface modification on the at least one turbine through bolt contact surface positioned on the shaft of the turbine through bolt.

7. A fatigue resistant turbine through bolt, comprising:
a base material covered by a first surface modification and a second surface modification;
wherein the first surface modification is in contact with the base material and is a low plasticity burnished layer that increases the residual compressive stresses on an outer surface of the turbine through bolt;
wherein the second surface modification covers the first surface modification and is a spinel oxide layer on the low plasticity burnished layer; and
wherein the first surface modification is positioned on at least one turbine through bolt contact surface positioned on a shaft of the turbine through bolt and wherein the second surface modification is positioned on the first surface modification on the at least one turbine through bolt contact surface positioned on the shaft of the turbine through bolt.

8. The fatigue resistant turbine through bolt of claim 7, wherein the base material is INCO 718 formed at least from a combination of Ni, Mo and Cr, wherein the base material is formed at least from a combination of between 50 percent and 55 percent Nickel, between 17 percent and 21 percent Chromium, up to one percent Cobalt, between 0.65 percent and 1.15 Titanium, between 4.75 percent and 5.5 percent Columbium plus Tantalum, between 0.2 percent and 0.8 percent Aluminum, between 2.8 percent and 3.3 percent Molybdenum and the remainder iron.

9. A method of forming a turbine through bolt with a low coefficient-of-friction surface modification to reduce contact friction stresses, comprising:
receiving a turbine through bolt formed from at least one base material;
subjecting the at least one turbine through bolt contact surface positioned on the shaft of the turbine through bolt to LPB to induce a residual compressive stress, thereby forming a first surface modification on the at least one turbine through bolt contact surface; and
exposing the turbine through bolt to a low temperature stress relief process in an oxidizing environment having a temperature less than 593 degrees Celsius for a period of time between two hours and 48 hours to form a second surface modification on the first surface modification on the at least one turbine through bolt contact surface positioned on a shaft of the turbine through bolt.

10. The method of claim 9, wherein subjecting the at least one turbine through bolt contact surface to LPB comprises subjecting the at least one turbine through bolt contact surface to LPB to induce a minimum of 100 ksi residual compressive stress.

11. The method of claim 9, wherein receiving the turbine through bolt formed from the at least one base material comprises receiving the turbine through bolt formed from the base material formed from INCO 718, which is formed at least from a combination of Ni, Mo and Cr.

12. The method of claim 11, wherein receiving the turbine through bolt formed from the at least one base material comprises receiving the turbine through bolt formed from the base material INCO 718, wherein the base material is formed at least from a combination of between 50 percent and 55 percent Nickel, between 17 percent and 21 percent Chromium, up to one percent Cobalt, between 0.65 percent and 1.15 Titanium, between 4.75 percent and 5.5 percent Columbium plus Tantalum, between 0.2 percent and 0.8 percent Aluminum, between 2.8 percent and 3.3 percent Molybdenum and the remainder iron.

13. A fatigue resistant turbine through bolt, comprising:
a base material covered by a surface modification;
wherein the surface modification is in contact with the base material and is a spinel oxide layer on the base material; and
wherein the surface modification is positioned on at least one turbine through bolt contact surface positioned on a shaft of the turbine through bolt.

14. The fatigue resistant turbine through bolt of claim 13, wherein the spinel oxide surface modification is formed from one or more of (Ni Fe) oxide; (Ni, Cr, Ti) oxide; and (Cr) oxide.

15. The fatigue resistant turbine through bolt of claim 13, wherein the base material is formed from INCO 718, which is formed at least from a combination of Ni, Mo and Cr.

16. The fatigue resistant turbine through bolt of claim 13, wherein the turbine through bolt is formed from INCO 718, wherein the base material is formed at least from a combination of between 50 percent and 55 percent Nickel, between 17 percent and 21 percent Chromium, up to one percent Cobalt, between 0.65 percent and 1.15 Titanium, between 4.75 percent and 5.5 percent Columbium plus Tantalum, between 0.2 percent and 0.8 percent Aluminum, between 2.8 percent and 3.3 percent Molybdenum and the remainder iron.
